(19) United States
(12) Patent Application Publication
(10) Pub. No.: US 2025/0240703 A1
(43) Pub. Date: Jul. 24, 2025

(54) Handling Attempt Counters When Unavailability Period Is Activated In Mobile Communications

(71) Applicant: MediaTek Singapore Pte. Ltd., Singapore (SG)

(72) Inventors: Marko Niemi, Oulu (FI); Puneet Puneet, Bengaluru KA (IN)

(21) Appl. No.: 19/032,067

(22) Filed: Jan. 19, 2025

(30) Foreign Application Priority Data
Jan. 24, 2024 (IN) IN202421005048

(51) Int. Cl. H04W 48/02

(52) U.S. Cl. CPC H04W 48/02

(57) ABSTRACT

Techniques pertaining to handling attempt counters when an unavailability period is activated in mobile communications are described. An apparatus (e.g., a user equipment (UE) determines an occurrence of a condition related to an unavailability period such as, for example, the unavailability period being activated. In response to the determining, the apparatus resets a counter such as, for example, a service request attempt counter, an attach attempt counter, a tracking area updating (TAU) attempt counter, and/or a registration attempt counter.

### CROSS REFERENCE TO RELATED PATENT APPLICATION(S)

The present disclosure claims the priority benefit of Indian Patent Application No. 202421005048, filed 24 Jan. 2024, the content of which herein being incorporated by reference in its entirety.

### TECHNICAL FIELD

The present disclosure is generally related to mobile communications and, more particularly, to handling attempt counters when an unavailability period is activated in mobile communications.

### BACKGROUND

In wireless communications such as mobile communications under the current 3^{rd} Generation Partnership Project (3GPP) specification, a registration attempt counter needs to be reset when a user equipment (UE) is in the substate 5GMM-DEREGISTERED.ATTEMPTING-REGISTRATION or 5GMM-REGISTERED.ATTEMPTING-REGISTRATION-UPDATE, and: (a) a current tracking area identity (TAI) is changed; (b) a timer T3502 expires; or (c) a timer T3346 is started. If the registration attempt counter is equal to 5, the UE is to delete the TAI list, a last visited registered TAI and a list of equivalent public land mobile networks (PLMNs), if any, or a list of equivalent standalone non-public networks (SNPNs), if any, and start timer T3502 if the value of the timer as indicated by a network is not zero. The value of timer T3502 can be sent by the network to the UE in the REGISTRATION ACCEPT message. The UE is to apply this value in all tracking areas of the registration area assigned to the UE, until a new value is received. The value of timer T3502 can be sent by the network to the UE in the REGISTRATION REJECT message during the initial registration. If a REGISTRATION REJECT message including timer T3502 value was received integrity protected, the UE is to apply this value until a new value is received with integrity protection or a new PLMN or SNPN is selected. Otherwise, the default value of this timer is used. The default value of this timer is also used by the UE in the following cases: (a) a REGISTRATION ACCEPT message is received without a value specified, and a 5^{th} Generation System (5GS) registration type information element (IE) in the REGISTRATION REQUEST message is not set to “periodic registration updating”; (b) the UE does not have a stored value for this timer; (c) a new PLMN which is not in the list of equivalent PLMNs or a new SNPN has been entered, the initial registration procedure fails, the registration attempt counter is equal to 5 and no REGISTRATION REJECT message was received from the new PLMN or SNPN; (d) the network indicates that the timer is “deactivated”; or (e) a new PLMN which is not in the list of equivalent PLMNs or a new SNPN has been entered, the registration procedure for mobility and periodic registration update fails and the registration attempt counter is equal to 5. When an unavailability period is activated, all non-access stratum (NAS) timers are stopped and associated procedures aborted except for timers T3512, T3346, T3447, T3396, T3584, T3585, any back-off timers, T3247, and the timer T controlling the periodic search for HPLMN or EHPLMN or higher prioritized PLMNs.

However, when the unavailability period is activated, then the UE stops T3502 timer, then UE is not resetting the registration attempt counter, service attempt counter, attach attempt counter and tracking area update counter. If the UE does not reset these counters, the UE would not be able to perform registration procedure when the UE comes out of unavailability period since counter is maximum. Therefore, there is a need for a solution of handling attempt counters when an unavailability period is activated in mobile communications.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions pertaining to handling attempt counters when an unavailability period is activated in mobile communications. It is believed that implementations of one or more of the schemes proposed herein may address or otherwise alleviate the issues described above.

In one aspect, a method may involve a UE determining an occurrence of a condition related to an unavailability period. The method may also involve the UE resetting a counter responsive to the determining.

In another aspect, a method may involve a UE determining an occurrence of a condition other than an unavailability period. The method may also involve the UE resetting a counter responsive to the determining.

It is noteworthy that, although the description provided herein may be in the context of certain radio access technologies, networks, and network topologies such as 5^{th} Generation (5G)/New Radio (NR)/Beyond Fifth-Generation (B5G) mobile communications, the proposed concepts, schemes and any variation(s)/derivative(s) thereof may be implemented in, for and by other types of radio access technologies, networks and network topologies such as, for example and without limitation, 4^{th} Generation (4G)/Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a block diagram of an example communication system under a proposed scheme in accordance with the present disclosure.

FIG. 3 is a flowchart of a second example process under a proposed scheme in accordance with the present disclosure.

FIG. 4 is a flowchart of a second example process under a proposed scheme in accordance with the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to handling attempt counters when an unavailability period is activated in mobile communications. According to the present disclosure, a number of possible solutions may be implemented separately or jointly. That is, although these possible solutions may be described below separately, two or more of these possible solutions may be implemented in one combination or another.

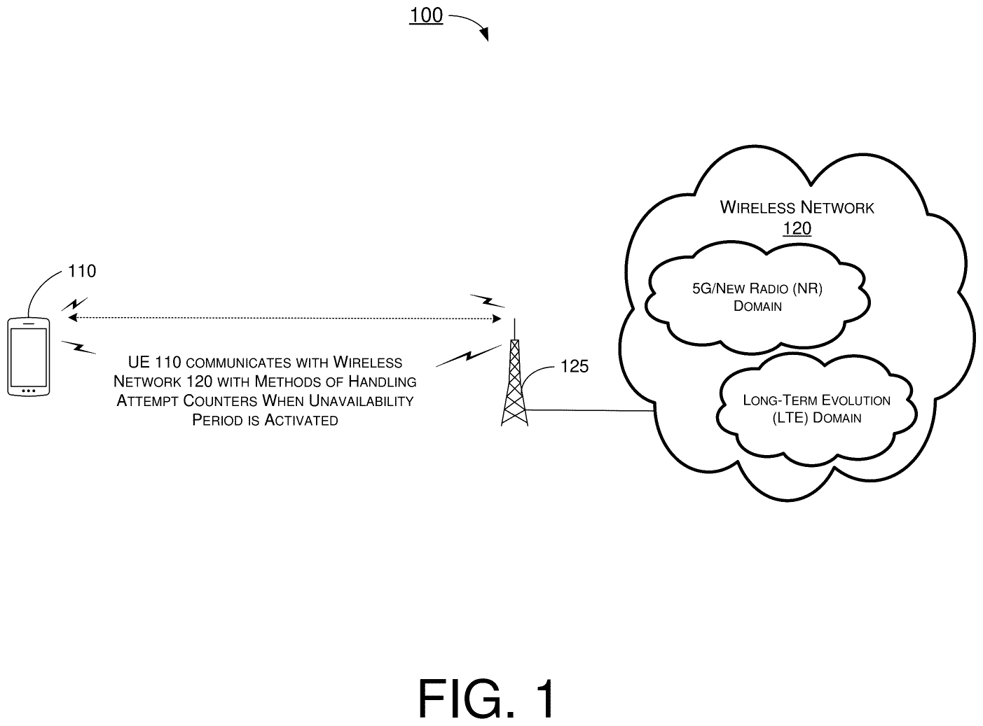

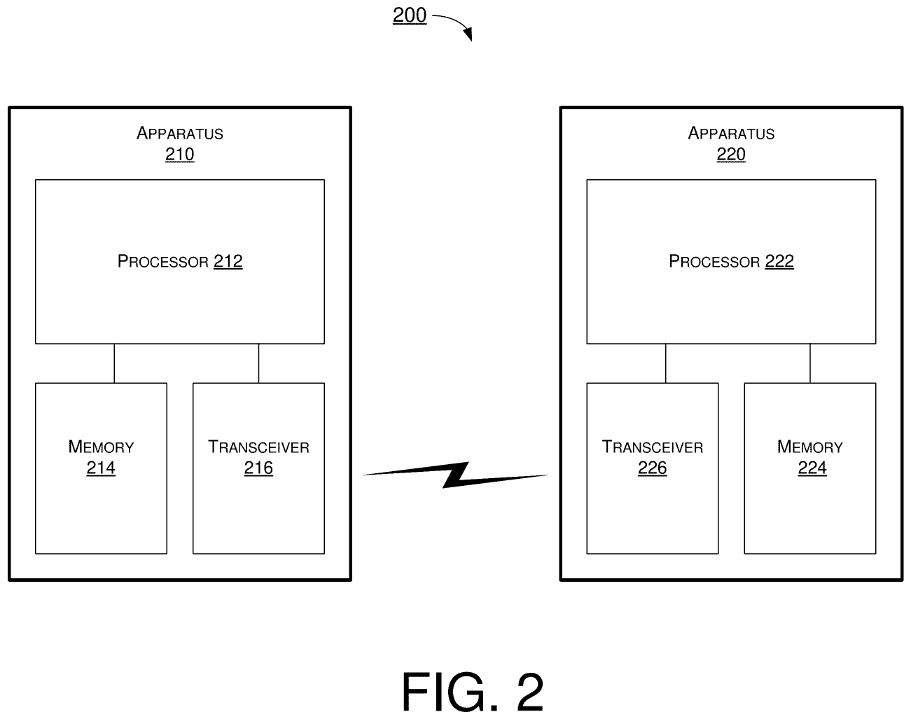

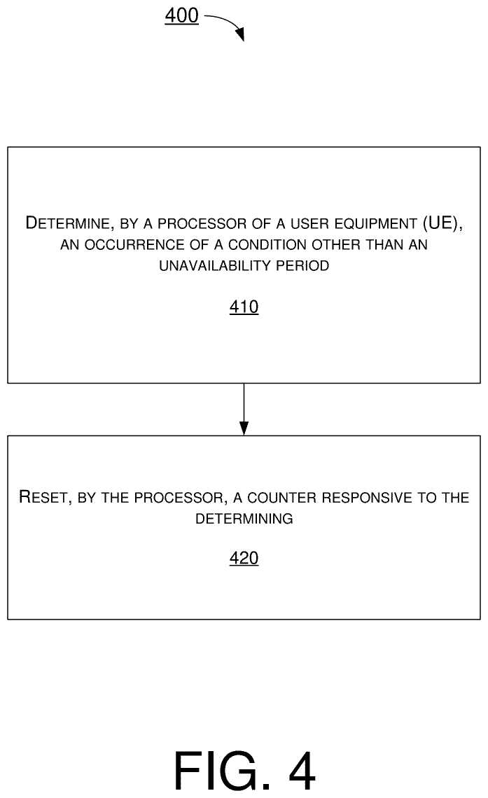

FIG. 1 illustrates an example network environment 100 in which various solutions and schemes in accordance with the present disclosure may be implemented. FIG. 2˜FIG. 4 illustrate examples of implementation of various proposed schemes in network environment 100 in accordance with the present disclosure. The following description of various proposed schemes is provided with reference to FIG. 1˜FIG. 4.

Referring to FIG. 1, network environment 100 may involve a UE 110, such as a mobile device or smartphone, in wireless communication with a wireless network 120 as part of a communication network. The wireless network 120 may be one or more PLMNs including 5G/NR domain, 4G/LTE domain, and 2G/3G domain. UE 110 may initially be in wireless communication with wireless network 120 via a base station or network node 125 (e.g., an eNB, gNB or transmit-receive point (TRP)). In network environment 100, UE 110 and the wireless network 120 may implement various schemes pertaining to handling attempt counters when an unavailability period is activated in mobile communications in accordance with the present disclosure, as described herein.

It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately. Moreover, as used herein, a lower layer may refer to a layer in the 5GMM protocol stack that is lower than the radio resource control (RRC) layer, such as a packet data convergence protocol (PDCP) layer, a radio control link (RLC) layer, a medium access control (MAC) layer, a physical (PHY) layer, or so forth.

Under a proposed scheme in accordance with the present disclosure, upon occurrence of one or more conditions, UE 110 may perform one or more actions. For instance, the one or more conditions may include one or more of the following: (1) UE 110 activating an unavailability period duration; (2) the unavailability period being activated for a discontinuous coverage; (3) the unavailability period being activated for other reasons (e.g., as defined in 3GPP Technical Specification (TS) 24.501 subclause 5.3.26); (4) an access stratum being deactivated for a 3GPP access; (5) the unavailability period being activated; (6) the access stratum being deactivated for the discontinuous coverage; (7) the access stratum being deactivated other reasons (e.g., as defined in 3GPP TS 24.501 subclause 5.3.26); (8) a mobile-initiated-connection-only (MICO) mode being activated; (9) a power-saving mode (PSM) being activated; and/or (10) a timer T3502 being stopped. Under the proposed scheme, in response to occurrence of one or more of aforementioned conditions, UE 110 may reset one or more counters. For instance, UE 110 may reset a service request attempt counter. Alternatively, or additionally, UE 110 may reset an attach attempt counter. Alternatively, or additionally, UE 110 may reset a tracking area updating (TAU) attempt counter. Alternatively, or additionally, UE 110 may reset a registration attempt counter.

### Illustrative Implementations

FIG. 2 illustrates an example communication system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to handling attempt counters when an unavailability period is activated in mobile communications, including the various schemes described above with respect to various proposed designs, concepts, schemes, systems and methods described above, including network environment 100, as well as processes described below.

Each of apparatus 210 and apparatus 220 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 210 and apparatus 220 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 210 and apparatus 220 may also be a part of a machine type apparatus, which may be an loT apparatus such as an immobile or a stationary apparatus, a home apparatus, a roadside unit (RSU), a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in an eNodeB in an LTE, LTE-Advanced or LTE-Advanced Pro network or in a gNB or TRP in a 5G network, an NR network, or an loT network.

In some implementations, each of apparatus 210 and apparatus 220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC or RISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged, and configured to perform specific tasks including those pertaining to handling attempt counters when an unavailability period is activated in mobile communications in accordance with various implementations of the present disclosure.

In some implementations, apparatus 210 may also include a transceiver 216 coupled to processor 212. Transceiver 216 may be capable of wirelessly transmitting and receiving data. In some implementations, transceiver 216 may be capable of wirelessly communicating with different types of wireless networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receive antennas for multiple-input multiple-output (MIMO) wireless communications. In some implementations, apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs/wireless networks of different RATs. In some implementations, transceiver 226 may be equipped with a plurality of antenna ports (not shown) such as, for example, four antenna ports. That is, transceiver 226 may be equipped with multiple transmit antennas and multiple receive antennas for MIMO wireless communications.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

Each of apparatus 210 and apparatus 220 may be a communication entity capable of communicating with each other using various proposed schemes in accordance with the present disclosure. For illustrative purposes and without limitation, a description of capabilities of apparatus 210, as a UE (e.g., UE 110), and apparatus 220, as a network node (e.g., network node 125) of a network (e.g., wireless network 120 as a 5G/NR mobile network), is provided below in the context of example processes 300 and 400.

### Illustrative Processes

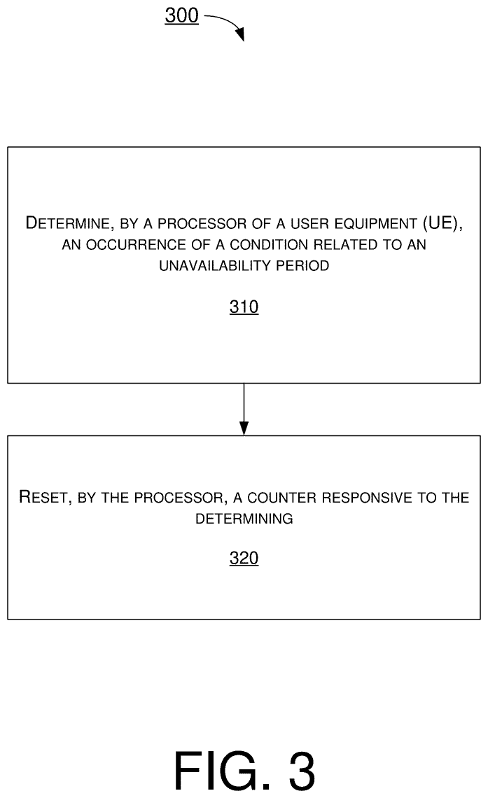

FIG. 3 illustrates an example process 300 in accordance with an implementation of the present disclosure. Process 300 may represent an aspect of implementing various proposed designs, concepts, schemes, systems and methods described above. More specifically, process 300 may represent an aspect of the proposed concepts and schemes pertaining to handling attempt counters when an unavailability period is activated in mobile communications in accordance with the present disclosure. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively, in a different order. Furthermore, one or more of the blocks/sub-blocks of process 300 may be executed repeatedly or iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a communication entity such as a network node or base station (e.g., network node 125) of a network (e.g., wireless network 120). Process 300 may begin at block 310.

At 310, process 300 may involve processor 212 of apparatus 210 determining an occurrence of a condition related to an unavailability period. Process 300 may proceed from 310 to 320.

At 320, process 300 may involve processor 212 resetting a counter responsive to the determining.

In some implementations, in resetting the counter, process 300 may involve processor 212 resetting a service request attempt counter. Alternatively, or additionally, in resetting the counter, process 300 may involve processor 212 resetting an attach attempt counter. Alternatively, or additionally, in resetting the counter, process 300 may involve processor 212 resetting a TAU attempt counter. Alternatively, or additionally, in resetting the counter, process 300 may involve processor 212 resetting a registration attempt counter.

In some implementations, the condition may include apparatus 210 activating the unavailability period. Alternatively, or additionally, the condition may include the unavailability period being activated for a discontinuous coverage. Alternatively, or additionally, the condition may include the unavailability period being activated for one or more UE reasons other than a discontinuous coverage. Such reason(s) may be the unavailability period being used for the UE to execute one or more required actions including, for example and not limited to, a silent modem reset, security patch update, operating system (OS) upgrade, modem software update, device reboot, and/or modem setting change via Open Mobile Alliance device management (OMA-DM). Alternatively, or additionally, the condition may include the unavailability period being activated.

FIG. 4 illustrates an example process 400 in accordance with an implementation of the present disclosure. Process 400 may represent an aspect of implementing various proposed designs, concepts, schemes, systems and methods described above. More specifically, process 400 may represent an aspect of the proposed concepts and schemes pertaining to handling attempt counters when an unavailability period is activated in mobile communications in accordance with the present disclosure. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively, in a different order. Furthermore, one or more of the blocks/sub-blocks of process 400 may be executed repeatedly or iteratively. Process 400 may be implemented by or in apparatus 210 and apparatus 220 as well as any variations thereof. Solely for illustrative purposes and without limiting the scope, process 400 is described below in the context of apparatus 210 as a UE (e.g., UE 110) and apparatus 220 as a communication entity such as a network node or base station (e.g., network node 125) of a network (e.g., wireless network 120). Process 400 may begin at block 410.

At 410, process 400 may involve processor 212 of apparatus 210 determining an occurrence of a condition other than an unavailability period. Process 400 may proceed from 410 to 420.

At 420, process 400 may involve processor 212 resetting a counter responsive to the determining.

In some implementations, in resetting the counter, process 400 may involve processor 212 resetting a service request attempt counter. Alternatively, or additionally, in resetting the counter, process 400 may involve processor 212 resetting an attach attempt counter. Alternatively, or additionally, in resetting the counter, process 400 may involve processor 212 resetting a TAU attempt counter. Alternatively, or additionally, in resetting the counter, process 400 may involve processor 212 resetting a registration attempt counter.

In some implementations, the condition may include an access stratum being deactivated for a 3GPP access. Alternatively, or additionally, the condition may include an access stratum being deactivated for a discontinuous coverage. Alternatively, or additionally, the condition may include the access stratum being deactivated for a reason other than a discontinuous coverage. Alternatively, or additionally, the condition may include a MICO mode being activated. Alternatively, or additionally, the condition may include a PSM being activated. Alternatively, or additionally, the condition may include a timer T3502 being stopped.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of a user equipment (UE), an occurrence of a condition related to an unavailability period; and
resetting, by the processor, a counter responsive to the determining.

2. The method of claim 1, wherein the resetting of the counter comprises resetting a service request attempt counter.

3. The method of claim 1, wherein the resetting of the counter comprises resetting an attach attempt counter.

4. The method of claim 1, wherein the resetting of the counter comprises resetting a tracking area updating (TAU) attempt counter.

5. The method of claim 1, wherein the resetting of the counter comprises resetting a registration attempt counter.

6. The method of claim 1, wherein the condition comprises the UE activating the unavailability period.

7. The method of claim 1, wherein the condition comprises the unavailability period being activated for a discontinuous coverage.

8. The method of claim 1, wherein the condition comprises the unavailability period being activated for one or more UE reasons other than a discontinuous coverage.

9. The method of claim 1, wherein the condition comprises the unavailability period being activated.

10. A method, comprising:
determining, by a processor of a user equipment (UE), an occurrence of a condition other than an unavailability period; and
resetting, by the processor, a counter responsive to the determining.

11. The method of claim 10, wherein the resetting of the counter comprises resetting a service request attempt counter.

12. The method of claim 10, wherein the resetting of the counter comprises resetting an attach attempt counter.

13. The method of claim 10, wherein the resetting of the counter comprises resetting a tracking area updating (TAU) attempt counter.

14. The method of claim 10, wherein the resetting of the counter comprises resetting a registration attempt counter.

15. The method of claim 10, wherein the condition comprises an access stratum being deactivated for a 3^{rd} Generation Partnership Project (3GPP) access.

16. The method of claim 10, wherein the condition comprises an access stratum being deactivated for a discontinuous coverage.

17. The method of claim 10, wherein the condition comprises an access stratum being deactivated for a reason other than a discontinuous coverage.

18. The method of claim 10, wherein the condition comprises a mobile-initiated-connection-only (MICO) mode being activated.

19. The method of claim 10, wherein the condition comprises a power-saving mode (PSM) being activated.

20. The method of claim 10, wherein the condition comprises a timer T3502 being stopped.
